(19) United States
(12) Patent Application Publication
(10) Pub. No.: US 2025/0128598 A1
(43) Pub. Date: Apr. 24, 2025

(54) OPERATING UNIT AND AGRICULTURAL WORKING MACHINE

(71) Applicant: Grimme Landmaschinenfabrik GmbH & Co. KG, Damme (DE)

(72) Inventors: Hendrik Hageböke, Melle (DE); Gustaaf Garrit Johan Van Zadelhoff, Damme (DE)

(21) Appl. No.: 18/691,515

(22) PCT Filed: Sep. 12, 2022
(86) PCT No.: PCT/EP2022/075301

§ 371 Date: Mar. 13, 2024

(30) Foreign Application Priority Data
Sep. 15, 2021 (DE) 20 2021 104 982.0

(51) Int. Cl. B60K 35/10; A01B 76/00

(52) U.S. Cl. CPC B60K 35/10; A01B 76/00; B60K 2360/126; B60K 2360/128; B60K 2360/131; B60K 2360/135

(57) ABSTRACT

A control unit for an agricultural working machine is provided. The control unit may be in a cab of a tractor and/or may control at least part of the working machine. A housing has a front side, a rear side, and end faces that connect the front and rear sides to one another. The housing has on the front side a plurality of control elements, as well as a display. The control elements are arranged on one side of a straight line extending along an edge of the display in a plan view of the front side.

### CROSS REFERENCE

This application claims priority to PCT Application No. PCT/EP2022/075301, filed Sep. 12, 2022, which itself claims priority to German Patent Application No. 20 2021 104982.0, filed Sep. 15, 2021, the entireties of both of which are hereby incorporated by reference.

### FIELD OF THE INVENTION

The present invention comprises a control unit for an agricultural working machine, in particular for arrangement in a cab of a tractor and/or for the control of at least part of the working machine, comprising a housing that has a front side, a rear side and end faces that connect the front and rear sides to one another, wherein the housing has on the front side and, in particular, on at least one end face, a plurality of control elements arranged, in particular, at least partially in rows, as well as a display.

### BACKGROUND OF THE INVENTION

In control units known on the market, for example the Claas Operator 1 and the Claas Cemis 700, the control elements are arranged around the display on different sides thereof. The arrangement of the control elements poses a problem in that when arranged to the left or right in the driver's cab of a tractor, operating with the left or right hand results in different experiences, which can have detrimental effects, particularly for contractors with a large number of tractors and drivers, as operation by means of the control unit differs. In particular, parts of the display may be covered during operation of the control elements, which complicates the operation of the working machine, for example an attached digging unit. The control unit can be used to control a sorting table or a bunker of the digging unit, for example, and therefore serves to control at least part of the working machine.

### BRIEF SUMMARY OF THE INVENTION

An object of the present invention is to design a generic control unit for improved operation in the tractor cab.

According to the invention, it is provided that the control elements are arranged on one side of a straight line extending along an edge of the display in a plan view of the front side. The one-sided arrangement of the control units means that a condition is created, particularly when the control unit is oriented in portrait mode, to operate it single-handedly without covering parts of the display on which the functions that can be controlled via the control elements and/or associated values can be displayed. For example, the control unit can be arranged on the right side in portrait mode, in such a manner that the display is on the left and the control elements on the right. This arrangement provides an unobstructed view of the display when operated with the right hand. For the left side, a corresponding arrangement results when the display unit is arranged in a mirror-symmetrical manner. The control unit is therefore particularly designed for single-handed operation on the non-display side.

By arranging the control elements on one side of the control unit that can be gripped with one hand, this region of the housing or control unit can be optimally designed for gripping, accordingly, i.e. provided with a thickness preferably ranging from 5 cm to 6 cm that is sufficient for gripping and also supporting the hand, while the region below the display can be narrower, i.e. designed with a smaller thickness, thereby saving space and material.

The front side is defined as the side of the control unit on which the display is arranged. In a flat arrangement on the ground, the front side would then also be the top side.

The straight line preferably extends along a longitudinal edge of the display, so that single-handed operation is particularly easy in the vertical positioning, in which the longitudinal edge is substantially upright (i.e. at an angle>45° to the ground), making it easy to operate with one hand. In particular, supporting the hand on the housing and operating the associated switches using the thumb during a field operation that typically involves vibrations can easily be realized.

A front side located on the control element side of the housing, the edge of which is particularly parallel to the straight line running along the edge of the display in plan view, can be ergonomically designed for better hand placement, so that, for example, the transition from the front side to the end face, to a longitudinal end face for example, projects slightly on the control element side and the end face then forms at least a slight undercut downwards towards the rear side in plan view.

Advantageously, the extent of the housing in the longitudinal direction of the display is greater than the extent of the housing in the transverse direction of the display, so that the housing is particularly bounded by a rectangular envelope in plan view. The display extends in particular over almost the entire height in a vertical arrangement or over almost the entire width of the part of the front side exhibiting the display in a landscape arrangement. The display is preferably provided on its three sides not facing the control elements with a housing edge that is less than 2 cm wide in plan view and particularly less than 1 cm wide, so that the unit has a sufficiently compact design. The housing edge is wider only on the front side facing the control elements.

Extensive tests have shown that optimal operation of the control unit is achieved when the width-to-length ratio of the display and a corresponding size of the part exhibiting the control elements are such that the width-to-length ratio is in a range of 1:3 +15% to 1:4−15%. The width-to-length ratio is preferably in a range of 1:3±15%. In a plan view of the front or top side, the control unit is preferably provided with an extent in the longitudinal direction of the display ranging from 20 cm to 25 cm and transversely thereto with an extent ranging from 14 cm to 16 cm. The display particularly has 1280×400 pixels.

The control elements preferably comprise at least one button, switch, in particular at least one toggle switch, at least one joystick and/or at least one rotary knob, in particular a rotary push knob. A rotary push knob particularly accompanies a plurality of at least six switches and/or membrane switches, at least four of which can be arranged in two rows.

A plurality of different control elements can be arranged on the front side. Hence, for example, in addition to six toggle switches arranged in a row, a row of buttons in the form of membrane switches may also be arranged parallel to them. Likewise, toggle switches or also joysticks may in addition be bordered by other control elements, for example membrane switches, towards the shorter end faces.

Particularly advantageous is an arrangement of a control unit according to the invention, in which the control elements comprise rotary knobs arranged on end faces that face away from one another and are, in particular, shorter. This means that with a mirror-symmetrical arrangement of the control unit on either the left or right side in a driver's cab, it is possible to create a symmetrical layout of the respective control elements.

For symmetrical operation of the individual buttons and control elements regardless of their arrangement in a driver's cab, it is advantageous for the control unit to have its own controller, with which the assignment of the control elements and an associated display representation can be changed. For example, this can be done via a control menu that can be accessed by means of a layer change button, where inputs regarding the orientation of the control unit can be made. Accordingly, the control unit in a variant of the invention of this kind is designed to adjust the display representation depending on the orientation of the housing or control unit.

The display representation comprises, in particular, the representation of the function of the control elements and/or their adjustment options and/or a parameter describing the adjustment of the working machine or a part thereof (e.g. inclination angle, conveying speed, height).

The adjustment of the display representation is particularly simple in a variant of the invention in which the control unit includes a gyroscope for detecting the orientation of the housing or the control unit and is designed to automatically adjust the assignment of the control elements depending on the orientation. In this case, the control unit can have at least two or three programmed assignments and display representations, depending on the orientation (portrait, landscape, opposite portrait). In practical use, the display on the display unit and possibly an assignment of the control elements can then automatically change so that an operator always sees the corresponding symbols correctly shown on the display.

In particular, the control elements designed as rotary knobs can be arranged in a protected manner in a recess on the respective end face, on the one hand allowing an outer side of the rotary knobs to align with the end face and, on the other, providing additional contact surfaces for the hand or fingers of the operator, ensuring safe operation of the rotary knobs even during field use and operation. The recesses on the end face can each be configured in such a manner as to extend over the entire height of the end face, allowing the rotary knob to be operated both from the front and also the back, for example using a pointing finger arranged on the rear side.

The control elements are particularly positioned mirror-symmetrically on the front side, wherein a mirror axis runs transversely to the longitudinal extension of the display, optimizing the arrangement and assignment of the control elements.

The housing of the control unit may have a recessed grip and/or grip bulge on the rear side of the part containing the control elements, which grip and/or bulge can be gripped or grasped with the fingers and extends or extend at least 4 cm in the longitudinal direction of the housing. This allows for safer operation of the control elements while the control unit is being held. A housing design of this kind is particularly advantageous for the arrangement of the control unit not in a stationary manner in a driver's cab, but in a mobile manner on the working machine, for example, connected with a cable.

In a development according to the invention, the display, for example an LCD display, is designed to be touch-insensitive and is not therefore a touch display. A touch display could not be operated by individuals wearing gloves, so that in particular, operation of the control elements with gloves is possible.

Advantageously, the part of the front side with the display is angled towards the part of the front side containing the control elements. In a side view of an end face of the control unit, it can be seen that a surface lying on the surface of the display is angled with respect to the surface on which the control elements are arranged. This makes the operation of the display unit more ergonomic, as operating the control elements with one hand does not require twisting the hand, in order to have an optimal view of the display. In particular, the housing towards the end face, located on the longitudinal side of the display facing away from the control elements, has a tapered design.

The control unit is equipped with IT resources, in particular a controller and associated electronics, and the IT resources are programmed to be ISOBUS-compatible and, in particular, capable of being integrated into an ISOBUS system as part thereof. In particular, the control unit is designed as an ISOBUS-AUX-N control unit, wherein the control unit preferably comprises two joysticks and/or at least two toggle switches to allow flexible operation of even more complex agricultural machinery as an ISOBUS-AUX-N device. Alternatively, the control unit can also operate without an ISOBUS terminal and function as a stand-alone device via ISOBUS. For this purpose, the agricultural machine or the part thereof to be controlled by means of the control unit makes its auxiliary functions known to the control unit. The control unit recognizes the associated inputs and activates them after appropriate assignment. The representation of the assignment on the display is also derived from this. The programs running on the IT resources are designed to perform these functions.

According to a further embodiment of the invention, the control unit can be designed to control and therefore operate multiple parts of the agricultural machine or multiple parts of different agricultural machines, thereby combining and replacing a plurality of different control units. The control unit can therefore be designed to operate different agricultural machines. In particular, switching between different parts of the agricultural machine can also occur during operation by pressing and possibly confirming a layer change button or a control element designed as a working set change button, for example a membrane switch.

The control unit can preferably control multiple ISOBUS-compatible parts of one or more agricultural machines, e.g. the sorting table and the bunker of a digging machine. The IT resources present in the control unit are each equipped accordingly with an executable program designed to integrate the parts of one or more different agricultural machines, also called implements, with their respective functions and control the associated assignment of the control elements and, in particular, to adopt associated representations provided by the implements for the display. By means of the working set change button, it is then possible on the one hand to switch between the different parts of the implement and the associated displays. On the other hand, when using the same control unit, it is also possible to switch between different agricultural machines which may, however, be operated simultaneously by a tractor, for example. For instance, the control unit can be used to operate both a root chopper positioned in the front attachment and a digging machine located in the rear attachment.

The safety of operating an associated agricultural machine is increased when the control unit is provided with an impact switch via which an emergency stop can be triggered and is integrated accordingly into the communication between the control unit and a central system and/or the agricultural machine. The impact switch is preferably mounted or housed on an end face of the housing and particularly arranged in a central position there. An unintentional activation can be avoided by means of an additional frame around the impact switch.

Advantageously, the housing has a multi-part design and includes a particularly replaceable insert that comprises the control elements present on the front side. This allows for a uniform approach for different agricultural machines and easy adaptation to other agricultural machines. By replacing the insert with one having different control elements, the same housing can be used for control units of different agricultural machines. For example, the control unit can be used for adjusting the bunker of a harvesting machine in a driver's cab, in exactly the same way as for adjusting the sorting table on the sorting table itself, wherein the harvesting machine is either towed or has a self-propelled design.

The object referred to above is also solved by an agricultural machine that includes a control unit according to the invention, as described above or below, and which benefits from the advantages described above or below.

### BRIEF DESCRIPTION OF THE DRAWINGS

Reference is now made more particularly to the drawings, which illustrate the best presently known mode of carrying out the invention and wherein similar reference char-acters indicate the same parts throughout the views.

FIG. 1 shows an object according to the invention in a perspective view.

FIG. 2 shows the object according to FIG. 1 with the display turned on showing an exemplary assignment of the control elements.

FIG. 3 shows the object according to FIG. 1 in an end-face view.

FIG. 4 shows the object according to FIG. 1 in a bottom view.

FIG. 5 shows a perspective representation of another object according to the invention.

FIG. 6 shows the object according to FIG. 5 in an upright position for operation with the left hand.

FIG. 7 shows the object according to FIG. 5 in an upright position for operation with the right hand.

### DETAILED DESCRIPTION OF THE INVENTION

Individual technical features of the exemplary embodiments described below may also lead to developments according to the invention in combination with the features of the independent claim. Wherever appropriate, at least partially identical parts are provided with identical reference signs.

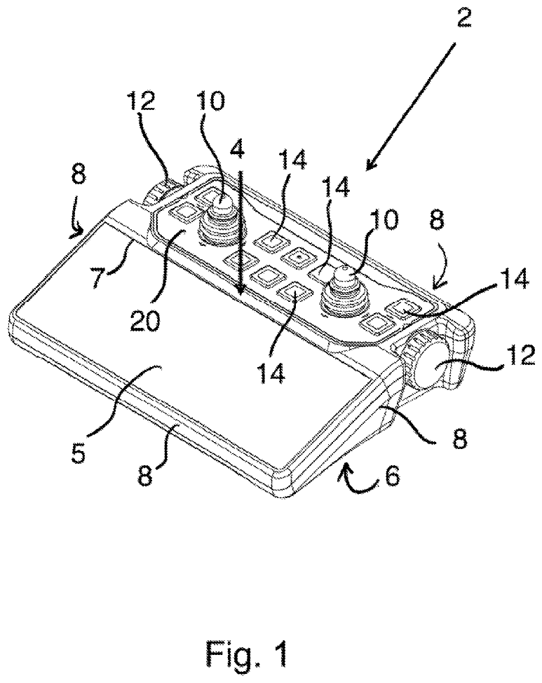

A control unit 2 for an agricultural machine according to the invention is provided with a housing comprising a front side 4, a rear side 6 and end faces 8 connecting the front side and rear side 4, 6 to one another. The housing on the front side 4 includes a display 5. Furthermore, control elements in the form of two joysticks 10 and a total of ten membrane switches 14 are arranged on the front side 4. In addition, rotary push-button switches 12 are arranged in recesses of the shorter end faces 8 (FIG. 1).

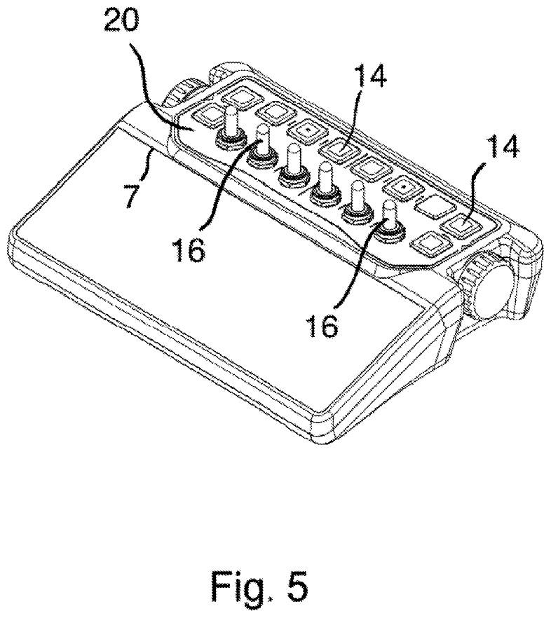

The control elements located on the front side are, moreover, part of an insert 20, which is inserted into a housing part of the housing forming the front side of the control unit 2 and is interchangeable as needed with other inserts containing different control elements or combinations of control elements. Other agricultural machines can therefore be equipped with an alternative control unit, for example the control unit shown in FIG. 5.

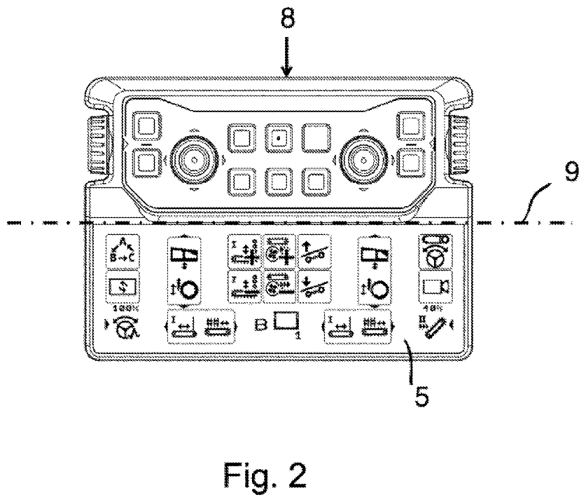

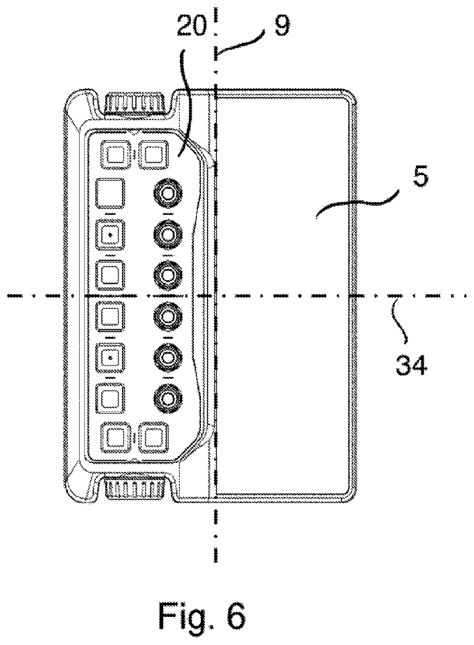

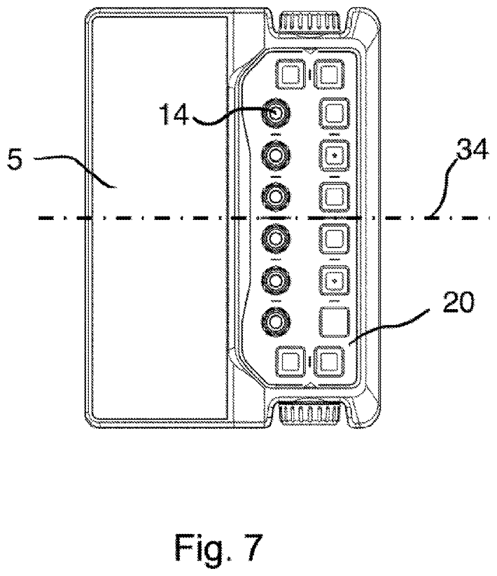

The control elements are arranged on one side of a straight line 9 extending along an edge 7 of the display 5 in a top view of the front side (FIG. 2). Due to this, particularly nearly halved division of the control unit 2, the control elements are located on one side for single-handed operation, particularly when the control unit is in an upright position (cf. FIGS. 6 and 7), meaning that they can be easily gripped to this extent without obstructing the display. It is also within the scope of the invention to mount the control unit depicted in FIG. 2 or FIG. 5, or another control unit according to the invention, in landscape orientation and rotated 180° with respect to the arrangement shown in FIG. 2. This is particularly appropriate when the insert 20 is fully equipped with membrane switches. In this case, the part of the control unit 2 containing the control elements has a surface that can be easily operated by finger pressure when the display is tilted at an angle suitable for reading.

An operator can support their palm on the upper end face 8 shown in FIG. 2 and, for example, when arranged on the left side of the driver's cab, where the display 5 is located to the right of the part containing the control elements, operate the control elements with the left hand.

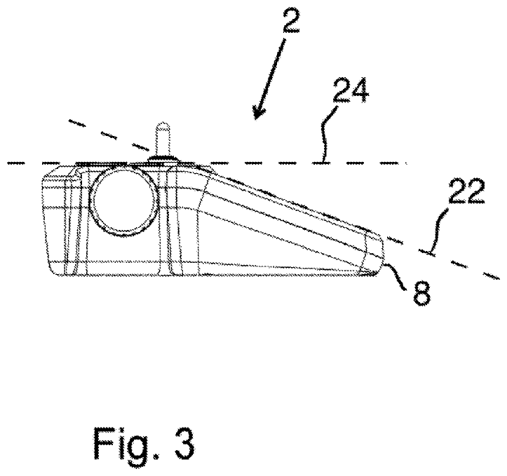

Typically, during operation, the control unit 2 is located to the left or right of the centre of the operator's body. To make gripping the control unit 2 easier, on one hand, and at the same time to improve readability, particularly for arrangements in which the control unit 2 is arranged in portrait mode, i.e. vertically oriented, the part of the front side 4 containing the display 5 is angled towards the part of the front side 4 containing the control elements. Accordingly, a plane 22 resting on the top of the display 5 is angled towards a plane 24 defining the part of the front side 4 containing the control elements on the front side (FIG. 3). While the housing part located below the part containing the control elements of the front side in FIG. 3 has a maximum thickness, the housing becomes narrower towards the end face 8, which is arranged on the right side in the figure, so that space is saved.

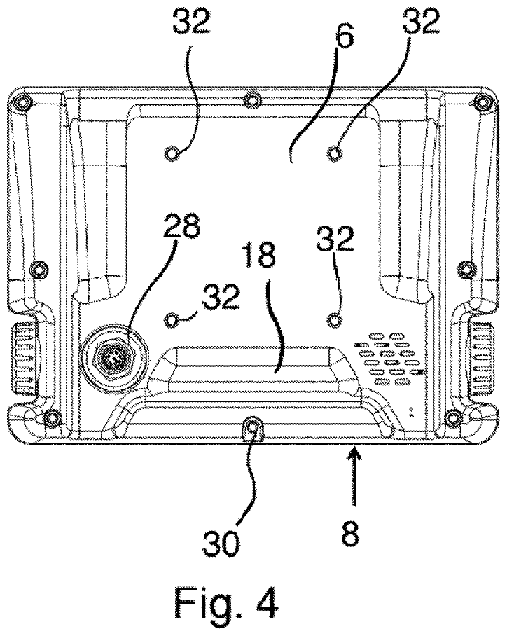

On the rear side 6, which also represents the bottom of the display unit 2, a grip recess 18 is provided, via which the display unit (FIG. 4) can be gripped. Furthermore, there is a connector 28 there for an ISOBUS-compatible plug. At the edge of the lower end face 8 in FIG. 4, a receptacle 30 is also provided for fastening an impact switch. A bracket can be attached to mounting points 32 for mounting the control unit 2 on the tractor side.

In the exemplary embodiment according to FIG. 5, an insert 20 is arranged with control elements in the form of toggle switches 16 and membrane switches 14. Just as in the exemplary embodiment in FIGS. 1 to 3, the control elements of this exemplary embodiment are mirror-symmetrical to a mirror axis 34, resulting in an assignment of the control elements in which an identical sequence of functions from top to bottom is possible for an arrangement according to either FIG. 6 or FIG. 7. For example, the layer change button is located at the top left (FIG. 6) or top right (FIG. 7), wherein the representation on the display 5 is adjusted accordingly. The assignment of the control elements and the representation on the display can be adjusted accordingly.

1. A control unit for an agricultural working machine, the control unit comprising:
a housing that has a front side, a rear side, and end faces that connect the front side and the rear sides to one another,
wherein the housing has on the front side a plurality of control elements as well as a display,
wherein the control elements are arranged on one side of a straight line extending along an edge of the display in a plan view of the front side.

2. The control unit as claimed in claim 1, wherein the straight line extends along a longitudinal edge of the display.

3. The control unit as claimed in claim 1, wherein an extent of the housing in a longitudinal direction of the display is greater than an extent of the housing in a transverse direction of the display.

4. The control unit as claimed in claim 3, wherein a width-to-length ratio of the display is in a range of 1:3+15% to 1:4−15%.

5. The control unit as claimed in claim 1, wherein the control elements comprise at least one button, switch, at least one joystick and/or at least one rotary knob.

6. The control unit as claimed in claim 5, wherein the control elements comprise rotary knobs arranged on end faces that face away from one another.

7. The control unit as claimed in claim 1, wherein the housing has a recessed grip and/or grip bulge on the rear side of a part containing the control elements.

8. The control unit as claimed in claim 1, wherein the display is touch-insensitive.

9. The control unit as claimed in claim 1, wherein the display is angled towards a part of the front side containing the control elements.

10. The control unit as claimed in claim 1, wherein the control unit is an ISOBUS control unit.

11. The control unit as claimed in claim 1, wherein the control unit operates multiple parts of the agricultural machine or multiple parts of different agricultural machines.

12. The control unit as claimed in claim 1, further including an impact switch.

13. The control unit as claimed in claim 1, wherein the control unit adjusts the display representation depending on an orientation of the control unit.

14. The control unit as claimed in claim 1, wherein the housing has a multi-part design and includes an insert that comprises the control elements present on the front side.

15. An agricultural machine comprising a control unit as claimed in claim 1.

16. The control unit as claimed in claim 1, wherein the plurality of control elements are arranged at least partially in rows on at least one end face if the housing.

17. The control unit as claimed in claim 5, wherein the switch is at least one toggle switch, and the at least one rotary knob is a rotary push knob.

18. The control unit as claimed in claim 10, wherein the ISOBUS control unit is an ISOBUS-AUX-N control unit.

19. The control unit as claimed in claim 12, wherein the impact switch is housed on an end face of the housing.

20. The control unit as claimed in claim 13, wherein the control unit includes a gyroscope for detecting the orientation of the control unit and is designed to automatically adjust the assignment of the control elements depending on the orientation.
